(19) United States
(12) Patent Application Publication
(10) Pub. No.: US 2024/0101857 A1
(43) Pub. Date: Mar. 28, 2024

(54) METHOD OF PRODUCING POROUS BODY, AND POROUS BODY

(71) Applicant: TOYOTA JIDOSHA KABUSHIKI KAISHA, Toyota-shi Aichi-ken (JP)

(72) Inventors: Kohei MATSUNOBU, Toyota-shi Aichi-ken (JP); Hiroshi Uyama, Suita-shi Osaka (JP)

(73) Assignee: TOYOTA JIDOSHA KABUSHIKI KAISHA, Toyota-shi Aichi-ken (JP)

(21) Appl. No.: 18/234,958

(22) Filed: Aug. 17, 2023

(30) Foreign Application Priority Data
Sep. 21, 2022 (JP) 2022-150267

(51) Int. Cl. C09D 135/02; C08F 122/10; C09D 4/00; C09D 5/02; C09D 7/20

(52) U.S. Cl. CPC C09D 135/02; C08F 122/1006; C09D 4/00; C09D 5/02; C09D 7/20

(57) ABSTRACT

A method for producing a porous body of the present disclosure includes: preparing a solution including a bi- or higher-functional polymerizable monomer and a solvent compatible with the polymerizable monomer, and not including a polymerization initiator; effecting direct radicalization of the polymerizable monomer included in the solution, polymerizing the polymerizable monomer, and forming, from the solution, a phase separation product including a porous body and the solvent; and vaporizing the solvent included in the phase separation product, the solvent including a predetermined solvent such as diethylene glycol diethyl ether.

### CROSS-REFERENCE TO RELATED APPLICATIONS

This application claims priority under 35 USC 119 from Japanese Patent Application No. 2022-150267 filed on Sep. 21, 2022, the disclosure of which is incorporated by reference herein in its entirety.

### BACKGROUND

### Technical Field

The present disclosure relates to a method for producing a porous body and to a porous body.

### Related Art

Polymeric porous bodies (hereinafter simply referred to as “porous bodies”) have been used in various fields. Porous bodies are used, for example, in foams (for example, cushion materials, etc.), separation membranes (for example, in water treatment, etc.), porous membranes (for example, in battery separators, etc.), and reflective substrates (for example, in lighting fixtures, etc.).

JP-A No. 2004-143427 discloses a method for forming a porous body. In the forming method disclosed in JP-A No. 2004-143427, a coating film is formed by coating a composition containing a binder resin, a photosensitive compound, and a photopolymerization initiator on a substrate. Next, the coating film is irradiated with ultraviolet rays in accordance with a desired pattern using an ultra-high-pressure mercury lamp. The coating film is then immersed in a solvent with respect to which the binder resin has poor solvability. Then, the poor solvent that has permeated into the coating film is volatilized. As a result, a porous body is obtained.

### SUMMARY

However, in the forming method disclosed in JP-A No. 2004-143427, the irradiation time of ultraviolet rays is about 1 minute to 2 minutes. Therefore, there is a need for a method for producing a porous body which can produce a porous body in a shorter time (in other words, having excellent productivity).

The present disclosure has been made in view of the above circumstances. An object of one embodiment of the present disclosure is to provide a method for producing a porous body, and a porous body, which have excellent productivity.

As a result of intensive studies on the above problem, the present inventors have found that by appropriately selecting the combination of the type of polymerizable monomer and the type of solvent and using an electron beam having a higher energy level than ultraviolet rays, the finding that porous bodies can be produced in a shorter time than in the prior art has been experimentally obtained. Based on this finding, the present inventors have completed the present disclosure.

The technique for solving the above problem includes the following embodiments.

<1> A method of producing a porous body, the method including: preparing a solution including a bi- or higher-functional polymerizable monomer and a solvent compatible with the polymerizable monomer, and not including a polymerization initiator; effecting direct radicalization of the polymerizable monomer included in the solution, polymerizing the polymerizable monomer, and forming, from the solution, a phase separation product including a porous body and the solvent; and vaporizing the solvent included in the phase separation product, the solvent including at least one selected from the group consisting of diethylene glycol diethyl ether, 2-methoxy ethanol, dimethylacetamide, ethylene glycol diacetate, γ-butyrolactone, propylene carbonate, dimethylformamide, tetradecane, 1-hexanol, 1-decanol, diethylene glycol monomethyl ether, diethylene glycol monoethyl ether, triethylene glycol monomethyl ether, ethanol, 2-propyl alcohol, 1-propyl alcohol, 1-methoxy-2-propanol, 2-ethoxyethanol, dimethyl sulfoxide, hexylene glycol, 1,4-dioxane, sulfolane, acetonitrile, dimethylethylene urea, tetraethylene glycol dimethyl ether, ethyl glycol acetate, and 2-pyrrolidone.

<2> The method of producing a porous body according to <1>, in which, in forming the phase separation product, the solution is irradiated with an electron beam and the polymerizable monomer is directly radicalized.

<3> The method of producing a porous body according to <2>, in which irradiation by the electron beam is performed so as to induce an absorbed dose of from 10 kGray to 200 kGray.

<4> The method of producing a porous body according to any one of <1> to <3>, in which, in preparing the solution, the content of the polymerizable monomer is from 5% by mass to 50% by mass relative to the total amount of the polymerizable monomer and the solvent.

<5> A porous body having a structural unit derived from a bi- or higher-functional polymerizable monomer, and not including a polymerization initiator.

According to the present disclosure, there are provided a method for producing a porous body, and a porous body, which have excellent productivity.

### BRIEF DESCRIPTION OF THE DRAWINGS

FIG. 1 is a scanning electron microscope (SEM) photograph (photographing magnification: 10000×) showing the surface of the porous body of Example 1.

FIG. 2 is an SEM photograph (photographing magnification: 10000×) of the surface of the porous body of Example 3.

FIG. 3 is an SEM photograph (photographing magnification: 10000×) of the surface of the porous body of Example 4.

FIG. 4 is an SEM photograph (photographing magnification: 10000×) of the surface of the porous body of Example 5.

FIG. 5 is a scanning electron microscope (SEM) photograph (photographing magnification: 10000×) showing the surface of the porous body of Example 32.

FIG. 6 is a scanning electron microscope (SEM) photograph (photographing magnification: 10000×) showing the surface of the porous body of Comparative Example 29.

### DETAILED DESCRIPTION

In the present disclosure, a numerical range indicated using “to” means a range including numerical values described before and after “to” as a minimum value and a maximum value, respectively. In the numerical ranges described in the present disclosure in a stepwise manner, the upper limit value or the lower limit value described in a certain numerical range may be replaced with the upper limit value or the lower limit value of another numerical range described in a stepwise manner. In the numerical ranges set forth in the present disclosure, the upper limit value or the lower limit value set forth in a numerical range may be replaced with a value set forth in the examples. In the present disclosure, a combination of two or more embodiments is an embodiment. In the present disclosure, the amount of each component means the total amount of a plurality of types of substances, unless otherwise specified, when a plurality of types of substances corresponding to each component are present. In the present disclosure, the term “process” includes cases in which the intended purpose of the process is achieved, even if it is not clearly distinguishable from other processes, as well as independent processes. In the present disclosure, “(meth)acrylate” represents at least one of an acrylate or a methacrylate, and “(meth)acryloyl group” represents at least one of an acryloyl group or a methacryloyl group.

(1) Method for Producing Porous Body

The method for producing a porous body of the present disclosure includes: preparing a solution containing a bi- or higher-functional polymerizable monomer and a solvent compatible with the polymerizable monomer and containing no polymerization initiator (hereinafter, also referred to as a “preparation process”), effecting direct radicalization of the polymerizable monomer contained in the solution, polymerizing the polymerizable monomer, and forming a phase separation product containing the porous body and the solvent from the solution (hereinafter, also referred to as a “formation process”), and vaporizing the solvent contained in the phase separation product (hereinafter, also referred to as a “vaporization process”), the solvent including at least one kind (hereinafter, also referred to as a “predetermined solvent”) selected from the group consisting of diethylene glycol diethyl ether, 2-methoxyethanol, dimethylacetamide, ethylene glycol diacetate, γ-butyrolactone, propylene carbonate, dimethylformamide, tetradecane, 1-hexanol, 1-decanol, diethylene glycol monomethyl ether, diethylene glycol monoethyl ether, triethylene glycol monomethyl ether, ethanol, 2-propyl alcohol, 1-propyl alcohol, 1-methoxy-2-propanol, 2-ethoxyethanol, dimethyl sulfoxide, hexylene glycol, 1,4-dioxane, sulfolane, acetonitrile, dimethylethylene urea, tetraethylene glycol dimethyl ether, ethyl glycol acetate, and 2-pyrrolidone.

A “polymerizable monomer” refers to a monomer containing an ethylenically unsaturated group. “Bi- or higher-functional” means having two or more ethylenically unsaturated groups in one molecule. A “polymerization initiator” refers to a compound (excluding monomers) which generates radicals upon irradiation with active energy rays (for example, electromagnetic waves, radiation, etc.). The polymerization initiator contains a known polymerization initiator used in ultraviolet curing. “Containing no polymerization initiator” means that the content of the polymerization initiator is 0.001% by mass or less based on the total amount of the solution, and includes a case in which the content of the polymerization initiator is 0% by mass. “Direct radicalization of the polymerizable monomer” means that polymerization proceeds even without generation of radicals by the polymerization initiator caused by irradiation with radiation (for example, electron beams, X-rays, gamma rays, etc.). A “solution” refers to a liquid phase which is uniformly compatible. A “porous body” refers to a polymer (solid phase) of a polymerizable monomer.

The method for producing a porous body of the present disclosure has the above-described structure, and is therefore excellent in productivity.

(1.1) Preparation Process

In the preparation process, a solution containing a bi- or higher-functional polymerizable monomer and a solvent compatible with the polymerizable monomer and containing no polymerization initiator is prepared.

The solution contains a bi- or higher-functional polymerizable monomer. In some embodiments, a bi- or higher-functional polymerizable monomer includes a (meth)acrylate having 2 or more (meth)acryloyl groups, and is a (meth)acrylate having 2 or more (meth)acryloyl groups.

Examples of the bi- or higher-functional polymerizable monomer include tricyclodecanedimethanol di(meth)acrylate, ethylene oxide (EO)-modified trimethylolpropane tri(meth)acrylate, and propylene oxide (PO)-modified trimethylolpropane tri(meth)acrylate.

Examples of a tri- or higher-functional polymerizable monomer include trimethylolpropane tri(meth)acrylate, pentaerythritol tetra(meth)acrylate, tris(acryloxyethyl)isocyanurate, dipentaerythritol hexa(meth)acrylate, and dipentaerythritol hydroxypenta(meth)acrylate.

These may be used singly or in combination of two or more thereof.

The solution contains the predetermined solvent. In some embodiments, the solution contains at least one selected from the group consisting of diethylene glycol diethyl ether, 2-methoxy ethanol, dimethylacetamide, ethylene glycol diacetate, γ-butyrolactone, propylene carbonate, dimethylformamide, tetradecane, 1-hexanol, 1-decanol, diethylene glycol monomethyl ether, diethylene glycol monoethyl ether, triethylene glycol monomethyl ether, ethanol, 2-propyl alcohol, 1-propyl alcohol, 1-methoxy-2-propanol, and 2-ethoxy ethanol.

In some embodiments, the content of the polymerizable monomer (hereinafter, also referred to as the “monomer ratio”) is not particularly limited, and relative to the total amount of polymerizable monomer and the solvent, is from 5% by mass to 50% by mass, 10% by mass to 40% by mass, or 10% by mass to 25% by mass. When the monomer ratio is in the range of 5% by mass to 50% by mass, the desired porous body can easily be obtained.

The solution does not contain a polymerization initiator. The solution may contain, in addition to the bi- or higher-functional polymerizable monomer and the solvent, an additive or may not contain an additive. Examples include dispersants, adhesion promoters such as silane coupling agents, antioxidants, anticoagulants, antifoaming agents, and surfactants.

(1.2) Formation Process

In the formation process, the polymerizable monomer contained in the solution is directly radicalized, the polymerizable monomer is polymerized, and a phase separation product including a porous body and a solvent is formed from the solution.

The method for directly radicalizing the polymerizable monomer is not particularly limited, and examples include a method of irradiating the solution with radiation (for example, electron beams, X-rays, and gamma rays). In some embodiments, the solution is irradiated with an electron beam to directly radicalize the polymerizable monomer. As a result, polymerization of the polymerizable monomer can proceed in a shorter time than with conventional methods such as ultraviolet curing.

When the polymerizable monomer is directly radicalized, the solution may be in the form of a coating film applied to the surface of a substrate.

In some embodiments, the irradiation of the electron beam is not particularly limited, and is carried out so as to have an absorbed dose of 10 kGray to 200 kGray. As a result, a desired porous body can easily be obtained.

In some embodiments, the absorbed dose of the electron beam is not particularly limited, and is 30 kGy to 100 kGy, or 30 kGy to 80 kGy.

The acceleration voltage of the electron beam may be appropriately adjusted according to the size of the porous body, and may be 80 kV to 300 kV.

(1.3) Vaporization Process

In the vaporization process, the solvent contained in the phase separation product is vaporized.

The method for vaporizing the solvent is not particularly limited, and examples thereof include heat drying, vacuum drying, and freeze drying. In heat drying, when the heating temperature is a temperature equal to or lower than the glass transition temperature of the polymerizable monomer or a polymer thereof, the solvent can be removed from the phase separation product without destroying the porous structure of the porous body. Examples of the heat drying include radiant heat drying using an infrared heater and air blow-drying using a blower.

(2) Porous Body

The porous body of the present disclosure has a structural unit derived from a bi- or higher-functional polymerizable monomer, and does not contain a polymerization initiator.

“Does not contain a polymerization initiator” means that the content of the polymerization initiator is 0.001% by mass or less based on the total amount of the porous body, and includes a case in which the content of the polymerization initiator is 0% by mass.

In some embodiments, the porous body of the present disclosure is a porous body produced by the method for producing a porous body of the present disclosure. The bi- or higher-functional polymerizable monomer is the same as the compounds exemplified as the bi- or higher-functional polymerizable monomer in the method for producing a porous body. The size of the porous body is not particularly limited, and is appropriately selected in accordance with the use of the porous body.

The porous body is suitably used, for example, for a foam (for example, a cushion material, etc.), a separation membrane (for example, in water treatment, etc.), a porous membrane (for example, in a battery separator, etc.), and a reflective substrate (for example, in a lighting fixture, etc.).

### EXAMPLES

Hereinafter, the present disclosure will be described in more detail with reference to Examples, but the present disclosure is not limited to these Examples.

### [1] Example 1

[1.1] Preparation Process

Tricyclodecanedimethanol diacrylate (functional group number: 2) was prepared as the polymerizable monomer. Diethylene glycol diethyl ether was prepared as a solvent.

The polymerizable monomer and the solvent were placed in a sample bottle. The monomer ratio was 30% by mass. The sample bottle was shaken by hand to stir the polymerizable monomer and solvent to obtain a solution.

The sample bottle was allowed to stand and the solution was visually observed for compatibility evaluation on the basis of the following criteria. The result of an acceptable compatibility assessment is [A1].

[A1]: No separation between the polymerizable monomer and the solvent was observed.

[B1]: Separation of the polymerizable monomer and the solvent was observed.

[A1] can be evaluated in terms of compatibility between the polymerizable monomer and the solvent. [B1] can be evaluated in terms of the polymerizable monomer and the solvent being incompatible.

In Example 1, the result of the compatibility evaluation was [A1].

[1.2] Formation Process

The solution was applied onto an aluminum foil by casting to form a coating film. The thickness of the coating film was 350 μm.

The coating film was irradiated with an electron beam to obtain an irradiated coating film. An area beam type electron beam irradiation apparatus of the belt conveyor type was used for irradiation of the electron beam. The acceleration voltage of the electron beam was 200 kV, and the absorbed dose was 50 kGy. The irradiation time of the electron beam was 1.2 seconds. The “irradiation time of the electron beam” indicates the time required for the coating film, which is moved by the belt conveyor, to pass through the irradiation area of the electron beam. An acceptable irradiation time is within 20 seconds.

The irradiated coating film was visually observed, and the polymerizability was evaluated on the basis of the following criteria. The result of an acceptable polymerization evaluation is [A2].

[A2]: The color of the irradiated coating film was white.

[B2]: The color of the irradiated coating film was transparent.

[A2] can be evaluated as indicating that polymerization of the polymerizable monomer has sufficiently progressed to form a porous body. [B2] can be evaluated as indicating that polymerization of the polymerizable monomer has not sufficiently progressed to form a porous body.

In Example 1, the result of the polymerizability evaluation was [A2]. In other words, it was found that polymerization of the polymerizable monomer had sufficiently progressed in the irradiated coating film in order to form a porous body.

[1.3] Vaporization Process

The aluminum foil on which the irradiated coating film was formed was placed on a hot plate. The temperature of the hot plate was set to 120° C., the irradiated coating film was heated at 120° C. for about 2 minutes, and the solvent was volatilized and removed. As a result, the polymer was separated from the irradiated film.

Using a scanning electron microscope (SEM) (imaging magnification: 10000× or 50000×), the surface of the polymer was observed and the porosity of the polymer was evaluated on the basis of the following criteria. The result of an acceptable porosity evaluation is [A3].

[A3]: Either closed pores or open pores were confirmed.

[B3]: Neither of closed pores or open pores could be confirmed.

[A3] can be evaluated as indicating that the polymer is a porous body. [B3] can be evaluated as indicating that the polymer is not a porous body.

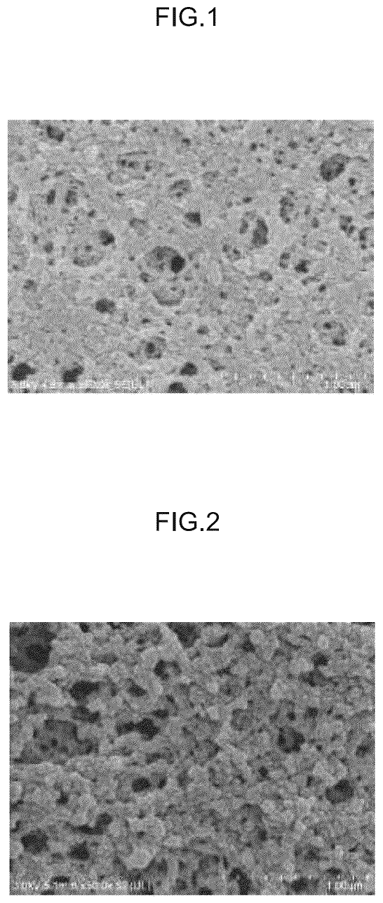

In Example 1, the result of the porosity evaluation was [A3]. In other words, the polymer was found to be a porous body. FIG. 1 shows an SEM photograph (photographing magnification: 10000×) of the surface of the porous body of Example 1.

### [2] Examples 2 to 33, and Comparative Examples 1 to 28

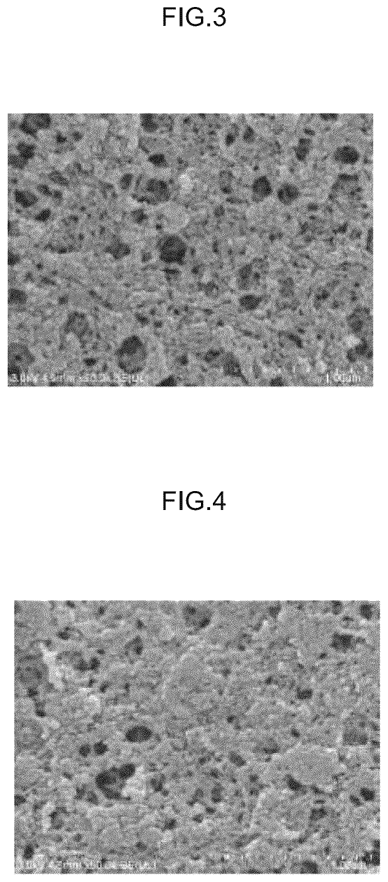

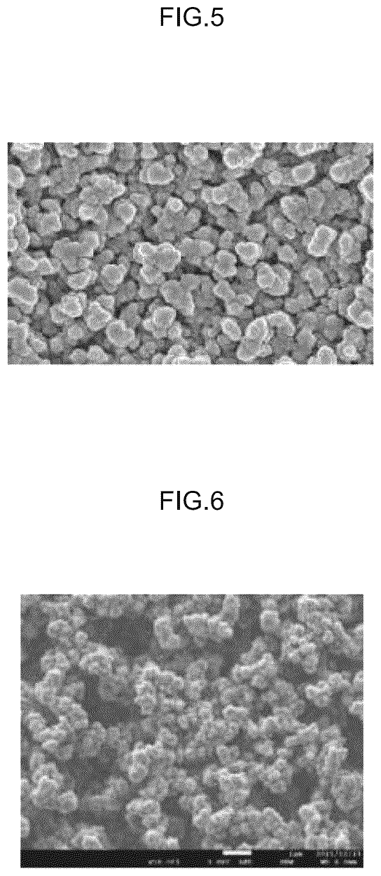

In Examples 2 to 33 and Comparative Examples 1 to 28, besides changing each of the polymerizable monomer, the solvent, the monomer ratio, the absorbed dose, and the irradiation time as shown in Tables 1 to 3, the preparation process, formation process, and vaporization process were performed in the same manner as in Example 1. Evaluation results of the compatibility evaluation, polymerizability evaluation, and porosity evaluation are shown in Tables 1 to 3, respectively. FIG. 2 shows an SEM photograph (photographing magnification: 10000×) of the surface of the porous body of Example 3. FIG. 3 shows an SEM photograph (photographing magnification: 10000×) of the surface of the porous body of Example 4. FIG. 4 shows an SEM photograph (photographing magnification: 10000×) of the surface of the porous body of Example 5. FIG. 5 shows an SEM photograph of the surface of the porous body of Example 32 (photographing magnification: 10000×).

### [3] Comparative Example 29

[3.1] Preparation Process

Tricyclodecanedimethanol diacrylate (functional group number: 2) was prepared as the polymerizable monomer. Triethylene glycol monomethyl ether was prepared as a solvent. 1-hydroxycyclohexylphenyl ketone (“Omnirad 184” manufactured by BASF Co., Ltd.) was prepared as the polymerization initiator.

The polymerizable monomer, the solvent, and the polymerization initiator were mixed to obtain a solution. The blending ratio (polymerizable monomer/solvent/polymerization initiator) was 19 parts by mass/80 parts by mass/1 part by mass.

[3.2] Formation Process

The solution was applied onto a substrate film (material: polyethylene terephthalate) using a spin coater, the mixture was dried at 80° C. for 15 minutes and cooled to form a coating film. A cover film (material: polyethylene terephthalate) was affixed to the coating film to obtain a resin sheet. The coating thickness of the resin sheet was 100 μm.

The resin sheet was irradiated with ultraviolet rays, heated at 85° C. for 2 minutes, and cooled to room temperature, whereby an irradiated resin sheet was obtained. An ultra-high-pressure mercury lamp was used for irradiation with ultraviolet rays. The UV radiation intensity was 220 mW/cm². The irradiation time of the ultraviolet rays was 60 seconds to 120 seconds.

The polymerizability of the irradiated coating film contained in the irradiated resin sheet was evaluated. The results of the polymerizability evaluation are shown in Table 3.

[3.3] Vaporization Process

The cover film was peeled from the irradiated resin sheet to obtain a coating film sheet. The coating film sheet was immersed in a methanol bath for 4 hours, and then removed from the methanol bath. Then, using an ultra-high-pressure mercury lamp, the surface side of the coating film and the substrate film side were irradiated with 1000 mJ/cm³, and the mixture was allowed to stand at room temperature overnight, and methanol was evaporated. As a result, a polymer formed on the substrate film was obtained.

The porosity of the polymer was evaluated. The results of the porosity evaluation are shown in Table 3. FIG. 6 shows an SEM photograph (photographing magnification: 10000×) of the surface of the porous body of Comparative Example 29.

### [4] Comparative Examples 30 to 34

In Comparative Examples 30 to 34, besides changing the solvent as shown in Table 3 and changing the blending ratio (polymerizable monomer/solvent/polymerization initiator) of Comparative Example 30, Comparative Example 32 and Comparative Example 34 to 39 parts by mass/60 parts by mass/1 part by mass, the preparation process, formation process, and vaporization process were performed in the same manner as in Comparative Example 29. The evaluation results of each of the polymerizability evaluation and the porosity evaluation are shown in Table 3.

TABLE 1

| | Preparation process | | | | | | | | | | |
|---|---|---|---|---|---|---|---|---|---|---|---|
| | Polymerizable | | | | | | | | | | |
| | monomer | | | Poly- | | | Formation process | | | | |
| | | No. of | | merization | Monomer | Compat- | Radical- | Absorbed | Irradiation | Polymer- | Polymer |
| | | functional | Solvent | Initiator | ratio | ibility | ization | dose | time | izability | Porosity |
| | Type | groups | Type | Type | Mass % | evaluation | Type | kGy | Sec. | evaluation | evaluation |
| Example 1 | Acryl A | 2 | Diethylene glycol | — | 30 | A1 | EB | 50 | 1.2 | A2 | A3 |
| | | | diethyl ether | | | | | | | | |
| Example 2 | Acryl A | 2 | Diethylene glycol | — | 50 | A1 | EB | 50 | 1.2 | A2 | A3 |
| | | | diethyl ether | | | | | | | | |
| Example 3 | Acryl A | 2 | Diethylene glycol | — | 15 | A1 | EB | 200 | 4.8 | A2 | A3 |
| | | | diethyl ether | | | | | | | | |
| Example 4 | Acryl A | 2 | Diethylene glycol | — | 30 | A1 | EB | 200 | 4.8 | A2 | A3 |
| | | | diethyl ether | | | | | | | | |
| Example 5 | Acryl A | 2 | Diethylene glycol | — | 50 | A1 | EB | 200 | 4.8 | A2 | A3 |
| | | | diethyl ether | | | | | | | | |
| Example 6 | Acryl A | 2 | 2-methoxy ethanol | — | 15 | A1 | EB | 10 | 0.48 | A2 | A3 |
| Example 7 | Acryl A | 2 | 2-methoxy ethanol | — | 30 | A1 | EB | 10 | 0.48 | A2 | A3 |
| Example 8 | Acryl A | 2 | 2-methoxy ethanol | — | 15 | A1 | EB | 50 | 1.2 | A2 | A3 |
| Example 9 | Acryl A | 2 | 2-methoxy ethanol | — | 30 | A1 | EB | 50 | 1.2 | A2 | A3 |
| Example 10 | Acryl A | 2 | 2-methoxy ethanol | — | 15 | A1 | EB | 200 | 4.8 | A2 | A3 |
| Example 11 | Acryl A | 2 | 2-methoxy ethanol | — | 30 | A1 | EB | 200 | 4.8 | A2 | A3 |
| Example 12 | Acryl A | 2 | Dimethylacetamide | — | 15 | A1 | EB | 50 | 1.2 | A2 | A3 |
| Example 13 | Acryl A | 2 | Dimethylacetamide | — | 30 | A1 | EB | 50 | 1.2 | A2 | A3 |
| Example 14 | Acryl A | 2 | Dimethylacetamide | — | 15 | A1 | EB | 200 | 4.8 | A2 | A3 |
| Example 15 | Acryl A | 2 | Dimethylacetamide | — | 30 | A1 | EB | 200 | 4.8 | A2 | A3 |

TABLE 2

| | Preparation process | | | | | | | | | | |
|---|---|---|---|---|---|---|---|---|---|---|---|
| | Polymerizable | | | | | | | | | | |
| | monomer | | | Poly- | | | Formation process | | | | |
| | | No. of | | merization | Monomer | Compat- | Radical- | Absorbed | Irradiation | Polymer- | Polymer |
| | | functional | Solvent | initiator | ratio | ibility | ization | dose | time | izability | Porosity |
| | Type | groups | Type | Type | Mass % | evaluation | Type | kGy | Sec. | evaluation | evaluation |
| Example 16 | Acryl A | 2 | Ethylene glycol | — | 15 | A1 | EB | 50 | 1.2 | A2 | A3 |
| | | | diacetate | | | | | | | | |
| Example 17 | Acryl A | 2 | γ-butyrolactone | — | 15 | A1 | EB | 50 | 1.2 | A2 | A3 |
| Example 18 | Acryl A | 2 | Propylene | — | 15 | A1 | EB | 50 | 1.2 | A2 | A3 |
| | | | carbonate | | | | | | | | |
| Example 19 | Acryl A | 2 | Dimethyl- | — | 15 | A1 | EB | 50 | 1.2 | A2 | A3 |
| | | | formamide | | | | | | | | |
| Example 20 | Acryl A | 2 | Tetradecane | — | 15 | A1 | EB | 50 | 1.2 | A2 | A3 |
| Example 21 | Acryl A | 2 | 1-hexanol | — | 15 | A1 | EB | 50 | 1.2 | A2 | A3 |
| Example 22 | Acryl A | 2 | 1-decanol | — | 15 | A1 | EB | 50 | 1.2 | A2 | A3 |
| Example 23 | Acryl A | 2 | Diethylene glycol | — | 15 | A1 | EB | 50 | 1.2 | A2 | A3 |
| | | | monomethyl ether | | | | | | | | |
| Example 24 | Acryl A | 2 | Diethylene glycol | — | 15 | A1 | EB | 50 | 1.2 | A2 | A3 |
| | | | monoethyl ether | | | | | | | | |
| Example 25 | Acryl A | 2 | Triethylene glycol | — | 15 | A1 | EB | 50 | 1.2 | A2 | A3 |
| | | | monomethyl ether | | | | | | | | |
| Example 26 | Acryl A | 2 | Ethanol | — | 15 | A1 | EB | 50 | 1.2 | A2 | A3 |
| Example 27 | Acryl A | 2 | 2-propyl alcohol | — | 15 | A1 | EB | 50 | 1.2 | A2 | A3 |
| Example 28 | Acryl A | 2 | 1-propyl alcohol | — | 15 | A1 | EB | 50 | 1.2 | A2 | A3 |
| Example 29 | Acryl A | 2 | 1-methoxy-2- | — | 15 | A1 | EB | 50 | 1.2 | A2 | A3 |
| | | | propanol | | | | | | | | |
| Example 30 | Acryl A | 2 | 2-ethoxyethanol | — | 15 | A1 | EB | 50 | 1.2 | A2 | A3 |
| Comparative | Acryl A | 2 | Diethylene glycol | — | 15 | A1 | EB | 50 | 1.2 | B2 | — |
| Example 1 | | | monobutyl ether | | | | | | | | |
| | | | acetate | | | | | | | | |
| Comparative | Acryl A | 2 | Diethylene glycol | — | 15 | A1 | EB | 50 | 1.2 | B2 | — |
| Example 2 | | | monoethyl ether | | | | | | | | |
| | | | acetate | | | | | | | | |
| Comparative | Acryl A | 2 | Ethylene glycol | — | 15 | A1 | EB | 50 | 1.2 | B2 | — |
| Example 3 | | | monophenyl ether | | | | | | | | |
| Comparative | Acryl A | 2 | Dipropylene glycol | — | 15 | A1 | EB | 50 | 1.2 | B2 | — |
| Example 4 | | | monomethyl ether | | | | | | | | |
| Comparative | Acryl A | 2 | N-methyl | — | 15 | A1 | EB | 50 | 1.2 | B2 | — |
| Example 5 | | | pyrrolidone | | | | | | | | |
| Comparative | Acryl A | 2 | Diethylene glycol | — | 15 | A1 | EB | 50 | 1.2 | B2 | — |
| Example 7 | | | dimethyl ether | | | | | | | | |
| Comparative | Acryl A | 2 | Acetone | — | 15 | A1 | EB | 50 | 1.2 | B2 | — |
| Example 8 | | | | | | | | | | | |
| Comparative | Acryl A | 2 | Ethyl acetate | — | 15 | A1 | EB | 50 | 1.2 | B2 | — |
| Example 9 | | | | | | | | | | | |
| Comparative | Acryl A | 2 | Methyl ethyl | — | 15 | A1 | EB | 50 | 1.2 | B2 | — |
| Example 10 | | | ketone | | | | | | | | |
| Comparative | Acryl A | 2 | Ethylene glycol | — | 15 | A1 | EB | 50 | 1.2 | B2 | — |
| Example 11 | | | dimethyl ether | | | | | | | | |

TABLE 3

| | Preparation process | | | | | | | | | | |
|---|---|---|---|---|---|---|---|---|---|---|---|
| | Polymerizable | | | | | | | | | | |
| | monomer | | | Poly- | | | Formation process | | | | |
| | | No. of | | merization | Monomer | Compat- | Radical- | Absorbed | Irradiation | Polymer- | Polymer |
| | | functional | Solvent | initiator | ratio | ibility | ization | dose | time | izability | Porosity |
| | Type | groups | Type | Type | Mass % | evaluation | Type | kGy | Sec. | evaluation | evaluation |
| Example 31 | Acryl B | 3 | Dimethylacetamide | | 30 | A1 | EB | 50 | 1.2 | A2 | A3 |
| Example 32 | Acryl B | 3 | Diethylene glycol | — | 30 | A1 | EB | 50 | 1.2 | A2 | A3 |
| | | | diethyl ether | | | | | | | | |
| Example 33 | Acryl B | 3 | 2-ethoxy ethanol | — | 30 | A1 | EB | 50 | 1.2 | A2 | A3 |
| Comparative | Acryl C | 1 | Dimethylacetamide | — | 30 | A1 | EB | 50 | 1.2 | B2 | — |
| Example 12 | | | | | | | | | | | |
| Comparative | Acryl C | 1 | Diethylene glycol | — | 30 | A1 | EB | 50 | 1.2 | B2 | — |
| Example 13 | | | diethyl ether | | | | | | | | |
| Comparative | Acryl C | 1 | Diethylene glycol | — | 30 | A1 | EB | 50 | 1.2 | B2 | — |
| Example 14 | | | monoethyl ether | | | | | | | | |
| Comparative | Acryl C | 1 | 2-ethoxy ethanol | — | 30 | A1 | EB | 50 | 1.2 | B2 | — |
| Example 15 | | | | | | | | | | | |
| Comparative | Acryl C | 1 | γ-butyrolactone | — | 30 | A1 | EB | 50 | 1.2 | B2 | — |
| Example 16 | | | | | | | | | | | |
| Comparative | Acryl C | 1 | 2-propyl alcohol | — | 30 | A1 | EB | 50 | 1.2 | B2 | — |
| Example 17 | | | | | | | | | | | |
| Comparative | Acryl C | 1 | Diethylene glycol | — | 30 | A1 | EB | 50 | 1.2 | B2 | — |
| Example 18 | | | monoethyl ether | | | | | | | | |
| | | | acetate | | | | | | | | |
| Comparative | Acryl A | 2 | Propylene glycol | — | 30 | B1 | — | — | — | — | — |
| Example 19 | | | | | | | | | | | |
| Comparative | Acryl B | 3 | Propylene glycol | — | 30 | B1 | — | — | — | — | — |
| Example 20 | | | | | | | | | | | |
| Comparative | Acryl A | 2 | Ethylene glycol | — | 30 | B1 | — | — | — | — | — |
| Example 21 | | | | | | | | | | | |
| Comparative | Acryl B | 3 | Ethylene glycol | — | 30 | B1 | — | — | — | — | — |
| Example 22 | | | | | | | | | | | |
| Comparative | Acryl A | 2 | 1,3-butanediol | — | 30 | B1 | — | — | — | — | — |
| Example 23 | | | | | | | | | | | |
| Comparative | Acryl B | 3 | 1,3-butanediol | — | 30 | B1 | — | — | — | — | — |
| Example 24 | | | | | | | | | | | |
| Comparative | Acryl A | 2 | 1,4-butanediol | — | 30 | B1 | — | — | — | — | — |
| Example 25 | | | | | | | | | | | |
| Comparative | Acryl B | 3 | 1,4-butanediol | — | 30 | B1 | — | — | — | — | — |
| Example 26 | | | | | | | | | | | |
| Comparative | Acryl A | 2 | 1,5-pentanediol | — | 30 | B1 | — | — | — | — | — |
| Example 27 | | | | | | | | | | | |
| Comparative | Acryl B | 3 | 1,5-pentanediol | — | 30 | B1 | — | — | — | — | — |
| Example 28 | | | | | | | | | | | |
| Comparative | Acryl A | 2 | Triethylene glycol | Initiator A | — | — | UV | — | 60~120 | A2 | A3 |
| Example 29 | | | monomethyl ether | | | | | | | | |
| Comparative | Acryl A | 2 | Triethylene glycol | Initiator A | — | — | UV | — | 60~120 | A2 | A3 |
| Example 30 | | | monomethyl ether | | | | | | | | |
| Comparative | Acryl A | 2 | γ-butyrolactone | Initiator A | — | — | UV | — | 60~120 | B2 | — |
| Example 31 | | | | | | | | | | | |
| Comparative | Acryl A | 2 | γ-butyrolactone | Initiator A | — | — | UV | — | 60~120 | B2 | — |
| Example 32 | | | | | | | | | | | |
| Comparative | Acryl A | 2 | Ethanol | Initiator A | — | — | UV | — | 60~120 | B2 | — |
| Example 33 | | | | | | | | | | | |
| Comparative | Acryl A | 2 | Ethanol | Initiator A | — | — | UV | — | 60~120 | B2 | — |
| Example 34 | | | | | | | | | | | |

In Tables 1 to 3, “Acryl A” represents tricyclodecane dimethanol diacrylate (functional group number: 2). “Acryl B” represents trimethylolpropane triacrylate (functional group number: 3). “Acryl C” represents isobornyl acrylate (functional group number: 1). “Initiator A” refers to 1-hydroxycyclohexylphenyl ketone. “EB” represents an electron beam. “UV” refers to ultraviolet rays. “Monomer ratio” refers to the ratio of polymerizable monomer to the total amount of polymerizable monomer and solvent.

The method of production of Examples 1 to 33 includes a preparation process, a formation process, and a vaporization process, and the solvent contains the predetermined solvent. As a result, in Examples 1 to 33, porous bodies were obtained even if the irradiation time of the electron beam was 20 seconds or less. As a result, it was found that the production methods of Examples 1 to 33 were methods for producing porous bodies that have excellent productivity.

Comparison between FIGS. 1 and 3 showed that there was no significant difference in the surface of the porous body, and it was found that the number of pores on the surface of the porous body was greater when the absorbed dose was higher.

As a result of comparison of FIGS. 2 to 4, it was found that the number of pores on the surface of the porous body tended to decrease as the monomer ratio increased.

When FIGS. 1 to 4 and FIG. 5 were compared, it was found that the porous body shown in FIG. 5 had a structure in which respective plural items of particulate matter were connected. As a result, it was found that a porous body can be obtained even when a trifunctional polymerizable monomer is used.

In the production methods of Comparative Examples 1 to 11, the solvent did not contain a predetermined solvent. As a result, the polymerizability evaluations of Comparative Examples 1 to 11 were [B2].

In the production methods of Comparative Examples 12 to 18, a polymerizable monomer having 2 or more functional groups was not used. Therefore, the polymerizability evaluations of Comparative Examples 12 to 18 were [B2]. This is presumed to be mainly due to the difficulty of forming a crosslinked structure with a monofunctional polymerizable monomer and the short chain length of a polymer having a structural unit derived from a monofunctional polymerizable monomer.

In the production methods of Comparative Examples 19 to 28, the solvent did not contain the predetermined solvent. Therefore, the compatibility evaluation of Comparative Examples 19 to 28 was [B1].

In the production methods of Comparative Examples 29 to 34, the solution contained a polymerization initiator, and irradiation with ultraviolet rays was performed in the formation process instead of irradiation with electron beams. Therefore, the irradiation time with ultraviolet rays was more than 20 seconds.

As a result, it was found that the production methods of Comparative Examples 1 to 34 were not methods for producing porous bodies that have excellent productivity.

What is claimed is:

1. A method of producing a porous body, the method comprising:
preparing a solution including a bi- or higher-functional polymerizable monomer and a solvent compatible with the polymerizable monomer, and not including a polymerization initiator;
effecting direct radicalization of the polymerizable monomer included in the solution, polymerizing the polymerizable monomer, and forming, from the solution, a phase separation product including a porous body and the solvent; and
vaporizing the solvent included in the phase separation product,
wherein the solvent includes at least one selected from the group consisting of diethylene glycol diethyl ether, 2-methoxy ethanol, dimethylacetamide, ethylene glycol diacetate, γ-butyrolactone, propylene carbonate, dimethylformamide, tetradecane, 1-hexanol, 1-decanol, diethylene glycol monomethyl ether, diethylene glycol monoethyl ether, triethylene glycol monomethyl ether, ethanol, 2-propyl alcohol, 1-propyl alcohol, 1-methoxy-2-propanol, 2-ethoxyethanol, dimethyl sulfoxide, hexylene glycol, 1,4-dioxane, sulfolane, acetonitrile, dimethylethylene urea, tetraethylene glycol dimethyl ether, ethyl glycol acetate, and 2-pyrrolidone.

2. The method of producing a porous body according to claim 1, wherein, in forming the phase separation product, the solution is irradiated with an electron beam and the polymerizable monomer is directly radicalized.

3. The method of producing a porous body according to claim 2, wherein irradiation by the electron beam is performed so as to induce an absorbed dose of from 10 kGray to 200 kGray.

4. The method of producing a porous body according to claim 1, wherein, in preparing the solution, a content of the polymerizable monomer is from 5% by mass to 50% by mass relative to a total amount of the polymerizable monomer and the solvent.

5. A porous body, comprising a structural unit derived from a bi- or higher-functional polymerizable monomer, and not including a polymerization initiator.
